(19) United States
(12) Patent Application Publication
(10) Pub. No.: US 2009/0026270 A1
(43) Pub. Date: Jan. 29, 2009

(54) SECURE CHECKOUT SYSTEM

(76) Inventors: Jonathan H. Connell, II, Cortlandt-Manor, NY (US); Myron D. Flickner, San Jose, CA (US); Norman Haas, Mount Kisco, NY (US); Arun Hampapur, Norwalk, CT (US); Sharathchandra U. Pankanti, Manhasset, NY (US)

Correspondence Address: HOFFMAN WARNICK LLC, 75 STATE ST, 14TH FLOOR, ALBANY, NY, 12207, US

(21) Appl. No.: 11/782,177

(22) Filed: Jul. 24, 2007

(51) Int. Cl. G06K 7/10

(52) U.S. Cl. 235/462.41

(57) ABSTRACT

Aspects of the present invention provide a secure checkout system comprising an image capture device (e.g., a camera) that is collocated with a handheld/portable scanner. The barcode of an item is scanned and an image of the item is recorded. It is then determined whether the identity of the item as determined based on the barcode is consistent with its appearance as determined from the image. If not, a discrepancy is registered. It is then determined whether the discrepancy is due to fraud (e.g., theft) or device error. In the case of the latter, the system can be updated to prevent a repeat of the error.

### CROSS-REFERENCE TO RELATED APPLICATIONS f

This application is related in some aspects to the commonly owned and co-pending application entitled “Secure checkout system,” filed May 31, 2007, and which is assigned attorney docket number END920070210US1 and U.S. patent application Ser. No. 11/756,391, the entire contents of which are herein incorporated by reference. This application is also related in some aspects to the commonly owned and co-pending application entitled “Portable Device-Based Shopping Checkout,” filed May 31, 2007, and which is assigned attorney docket number END920070211US1 and U.S. patent application Ser. No. 11/756,382, the entire contents of which are herein incorporated by reference.

### FIELD OF THE INVENTION

Aspects of the present invention generally relate to a secure checkout system. Specifically, an embodiment of the present invention relates to a system in which a portable/handheld barcode scanner and an image capture device (e.g., image capture device) are collocated for improved security in shopping checkout.

### BACKGROUND OF THE INVENTION

Marketplace security has become a rising concern over recent years. Security and anti-theft concerns have only increased with the pervasiveness of scanners at checkout stations. It has become increasingly frequent for perpetrators to switch and/or alter barcodes so that an item can be obtained for a cheaper price. In addition, many retailers also utilize image capture devices to catch shop lifters.

Unfortunately, current placement of image capture devices is either awkward, or of little use during the checkout process. Any current placement of image capture devices near checkout stations inevitably places them in the way of customer's arms, heads or bodies, creating opportunities for collisions, with damage to the person and/or the image capture devices. It also creates problems for the store, with regard to cleaning, theft, camera occlusions, etc. This is especially the case when the store clerk utilizes a handheld or portable scanner such as when scanning heavy or pass-around items.

In view of the foregoing, there exits a need for a solution that solves at least one of the above-referenced deficiencies in the related art.

### SUMMARY OF THE INVENTION

In general, aspects of the present invention provide a secure checkout system comprising an image capture device (e.g., a camera) that is collocated with a handheld/portable scanner. The barcode of an item is scanned and an image of the item is recorded. It is then determined whether the identity of the item as determined based on the barcode is consistent with its appearance as determined from the image. If not, a discrepancy is registered. It is then determined whether the discrepancy is due to fraud (e.g., theft) or device error. In the case of the latter, the system can be updated to prevent a repeat of the error. In either event, the scan, the image and a shopping event corresponding to the scan and image can be stored for future analysis.

A first aspect of the present invention provides a secure checkout method, comprising: receiving a scan of a barcode of an item via a handheld scanner; determining an identity of the item based on the barcode; receiving a capture of an image of the item via an image camera device collocated with the handheld scanner; and determining whether the identity is consistent with an appearance of the item as determined from the image.

A second aspect of the present invention provides a secure checkout system, comprising: a module for receiving a scan of a barcode of an item via a handheld scanner; a module for determining an identity of the item based on the barcode; a module for receiving a capture of an image of the item via an image camera device collocated with the handheld scanner; and a module for determining whether the identity is consistent with an appearance of the item as determined from the image.

A third aspect of the present invention provides a program product stored on a computer readable medium for securely checking out, the computer readable medium comprising program code for causing a computer system to: receive a scan of a barcode of an item via a handheld scanner; determine an identity of the item based on the barcode; receiving a capture of an image of the item via an image camera device collocated with the handheld scanner; and determine whether the identity is consistent with an appearance of the item as determined from the image.

A fourth aspect of the present invention provides a method for deploying a system for securely checking out, comprising: providing a computer infrastructure being operable to: receive a scan of a barcode of an item via a handheld scanner; determine an identity of the item based on the barcode; receive a capture of an image of the item via an image camera device collocated with the handheld scanner; and determine whether the identity is consistent with an appearance of the item as determined from the image.

A fifth aspect of the present invention provides computer software embodied in a propagated signal for securely checking out, the computer software comprising instructions for causing a computer system to: receive a scan of a barcode associated with an item via a handheld scanner; determine an identity of the item based on the barcode; receive a capture of an image of the item via an image camera device collocated with the handheld scanner; and determine whether the identity is consistent with an appearance of the item as determined from the image.

A sixth aspect of the present invention provides a data processing system for secure checkout, comprising: a memory medium having instructions; a bus coupled to the memory medium; and a processor coupled to the bus that when executing the instructions causes the data processing system to: receive a scan of a barcode associated with an item via a handheld scanner; determine an identity of the item based on the barcode; receive a capture of an image of the item via an image camera device collocated with the handheld scanner; and determine whether the identity is consistent with an appearance of the item as determined from the image.

A seventh aspect of the present invention provides a computer-implemented business method for secure checkout, comprising: receiving a scan of a barcode associated with an item via a handheld scanner; determining an identity of the item based on the barcode; receiving a capture of an image of the item via an image camera device collocated with the handheld scanner; and determining whether the identity is consistent with an appearance of the item as determined from the image.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative secure checkout system according to an embodiment of the present invention.

FIG. 2 depicts a more specific computerized implementation according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following Sections:

I. General Description

II. Computerized Implementation

### I. General Description

In general, an embodiment of the present invention provides a secure checkout system comprising an image capture device (e.g., a camera) that is collocated with a handheld/portable scanner. The barcode of an item is scanned and an image of the item is recorded. It is then determined whether the identity of the item as determined based on the barcode is consistent with its appearance as determined from the image. If not, a discrepancy is registered. It is then determined whether the discrepancy is due to fraud (e.g., theft) or device error. In the case of the latter, the system can be updated to prevent a repeat of the error. In either event, the scan, the image and a shopping event corresponding to the scan and image can be stored for future analysis.

As indicated above, an embodiment of the present invention provides a secure checkout system comprising an integrated scanning and image capture system in which one or more image capture device(s) (e.g., camera) and a barcode scanner are positioned within a common enclosure that is a component of a checkout station. The barcode of an item is scanned and an image of the item is recorded. The identity of the item as determined based on the barcode is compared to an appearance of the item as determined based on its image. If the two are inconsistent, a discrepancy is registered. It is then determined whether the discrepancy is due to fraud (e.g., theft) or device error. In the case of the latter, the system can be updated to prevent a repeat of the error.

The integrated device of an embodiment of the present invention should not result in an increase of volume of the enclosure of previous systems that house only barcode scanners. The enclosure of an embodiment of the present invention protects the image capture device(s) from collision, theft, dust and dir, water and similar fluids, etc. The image capture device(s) are generally located and oriented so that (1) they fit inside the small, already-somewhat-full space, (2) they are pointed in such a way that they can usefully see the desired field of view, and (3) they do not interfere with the optical paths required by the pre-existing barcode scanner light source, mirrors, and reflected light intensity sensor. In addition, they do not require increasing the dimensions of glass used, so that no additional risk of glass breakage is incurred.

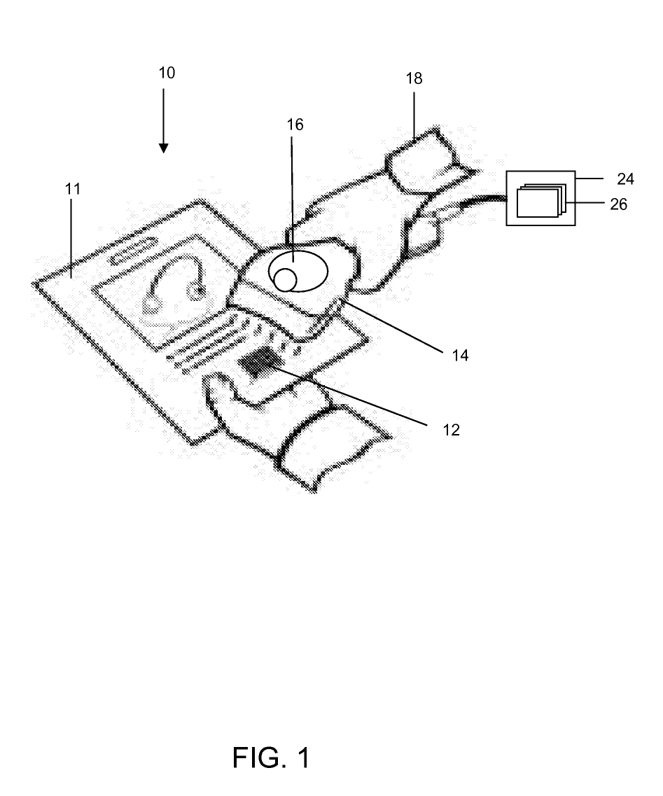

Referring now to FIG. 1, a secure checkout system 10 according to an embodiment of the present invention is shown. In general, secure checkout system 10 comprises handheld barcode scanner (hereinafter handheld scanner 14), at least one image capture device 16 (e.g., a still image camera, a video camera, etc.) that is collocated with handheld scanner 14, and a secure checkout program 24 having a set (at least one) of program modules 26. In being collocated with handheld scanner 14, image capture device 16 can be positioned near handheld scanner 14, attached to handheld scanner 14, and/or integrated within handheld scanner 14 as shown and described in application Ser. No. 11/756,391.

The functions of secure checkout system 10 will now be explained in greater detail. Specifically, a scan of a barcode 12 of an item 11 (e.g., a consumer product) will be received using handheld scanner 14. Based on the barcode 12, secure checkout system 10 (e.g., secure checkout program 24) will determine an identity of item 11. This occurs via known means such as cross-referencing a table of barcode values to product identities.

Before, after or simultaneous to the scan of the barcode, an image of item 11 will be captured by image capture device 16 (shown in FIG. 1), and processed to determine an appearance of the item 11 (which should be consistent with the identity as determined based on the scan of barcode 12). The sequence of capturing and processing the image is typically as follows: wait for low motion of item 11; take dark and bright pictures; segment item 11 from background 20; extract at least one visual feature of item 11 and determine the identity based on those visual features. This determination can be based on a comparison of the image to an electronic database or library of images associated with corresponding item identities. In addition, the appearance can be as general or as specific as desired. For example, the appearance can be specific so as to identify the item (e.g., a bottle of X brand cola), or it can be more general (e.g., a bottle of cola, or just cola based on the color).

Thereafter, the secure checkout system 10 will compare the identity of item 11 as determined based on the scan of barcode 12 to the appearance as determined based on the image to determine if the two are consistent with one another. If not, the secure checkout system will register a discrepancy and provide a notification of the discrepancy (at least one of a visual notification or an audible notification). Where there is a discrepancy, the secure checkout system will then determine whether the discrepancy is either error or fraud. For example, was the barcode tampered with or changed, or was the discrepancy due to device error. Where device error caused the discrepancy, the secure checkout system can be updated (e.g., in response to an operator's input) to reflect the true identity of the item and its association with the image just captured. Regardless, the scan, the image, and a shopping event to which they correspond/pertain can then be stored for post investigation.

### II. Computerized Implementation

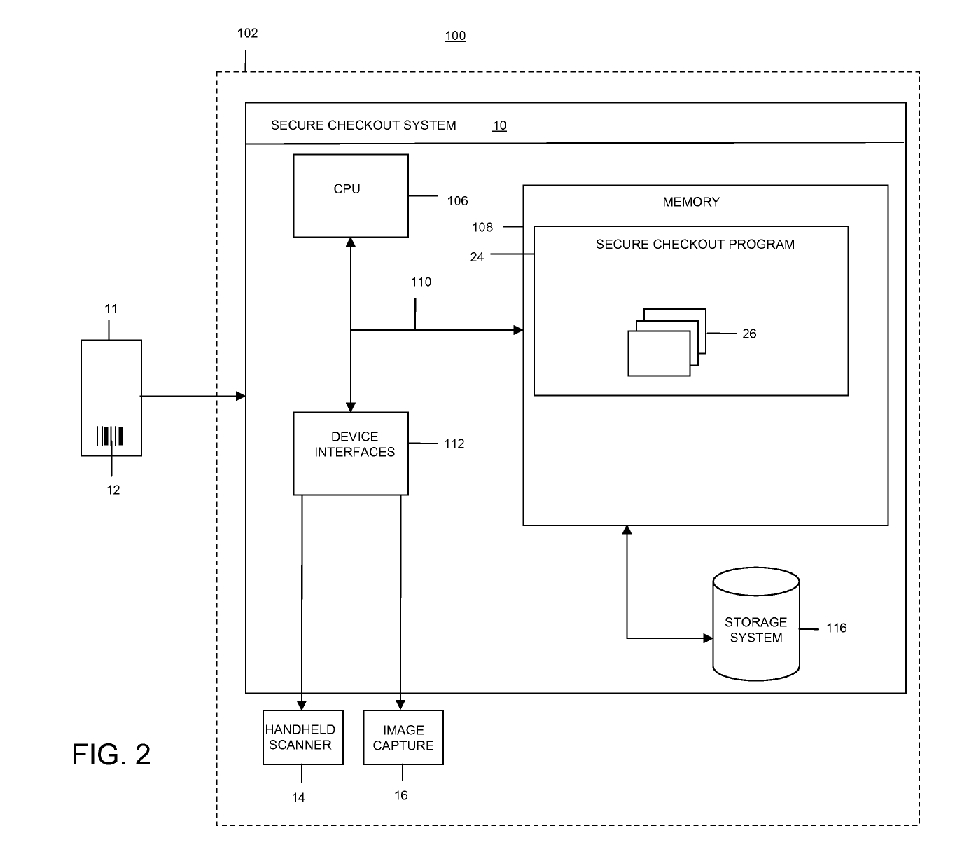

Referring now to FIG. 2, a computerized implementation 100 of an embodiment of the present invention is shown. As depicted, implementation 100 includes secure checkout system 10 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others.

As shown, secure checkout system 10 includes a processing unit 106, a memory 108, a bus 110, and device interfaces 112. Further, secure checkout system 10 is shown having barcode scanner 14 and image capture device 16 and storage system 116 that communicate with bus via device interfaces (although barcode scanner 14 and/or image capture device 16 alternatively could directly communicate with bus 110). In general, processing unit 106 executes computer program code, such as secure checkout program 24, which are stored in memory 108 and/or storage system 116. While executing computer program code, processing unit 106 can read and/or write data to/from memory 108, storage system 116, and/or device interfaces 112. Bus 110 provides a communication link between each of the components in secure checkout system 10. Although not shown, secure checkout system 10 could also include I/O interfaces that communicate with: one or more external devices such as a cash register, a keyboard, a pointing device, a display, etc.; one or more devices that enable a user to interact with secure checkout system 10; and/or any devices (e.g., network card, modem, etc.) that enable secure checkout system 10 to communicate with one or more other computing devices.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various process of the invention. Moreover, secure checkout system 10 is only representative of various possible computer systems that can include numerous combinations of hardware. To this extent, in other embodiments, secure checkout system 10 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, device interfaces 112 can comprise any module for exchanging information with one or more external device 114. Still further, it is understood that one or more additional components (e.g., system software, math co-processing unit, etc.) not shown in FIG. 2 can be included in secure checkout system 10.

Storage system 116 can be any type of system capable of providing storage for information under the present invention. To this extent, storage system 116 could include one or more storage devices, such as a magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into secure checkout system 10.

Shown in memory 108 of secure checkout system 10 is secure checkout program 24, which includes a set (at least one) of modules 26. The modules generally provide the functions of the present invention as described herein. For example (among other things), set of modules 26 is configured to: receive a scan of a barcode of item 11 via handheld scanner 14; determine an identity of item 11 based on the barcode; receive a capture of an image of item 11 via image capture device 16; process image 11 (e.g., segment item 11 from the background, extract visual feature(s) of item 11); determine an appearance the item 11 based on the image; determine whether the identity is consistent with the appearance; register a discrepancy if the identity is inconsistent with the appearance; determine whether the discrepancy is either an error or fraud; update secure checkout system 10 to prevent an error from being repeated; provide a notification of the discrepancy, the notification being at least one of a visual notification and an audible notification; and store the scan, the image, and a shopping event pertaining thereto for post investigation.

While shown and described herein as a secure checkout system, method, and program item, it is understood that the invention further provides various alternative embodiments. For example, in one embodiment, the invention provides a computer-readable/useable medium that includes computer program code to enable a computer infrastructure to provide smart scanning. To this extent, the computer-readable/useable medium includes program code that implements each of the various process of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 2) and/or storage system 116 (FIG. 2) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to provide smart scanning. In this case, the service provider can create, maintain, and support, etc., a computer infrastructure, such as computer infrastructure 102 (FIG. 2) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for smart scanning. In this case, a computer infrastructure, such as computer infrastructure 102 (FIG. 2), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as secure checkout system 10 (FIG. 2), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic device system/driver for a particular computing and/or processing device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or device devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A secure checkout method, comprising:
receiving a scan of a barcode associated with an item via a handheld scanner;
determining an identity of the item based on the barcode;
receive a capture of an image of the item via an image camera device collocated with the handheld scanner; and
determining whether the identity is consistent with an appearance of the item as determined from the image.

2. The secure checkout method of claim 1, further comprising:
registering a discrepancy if the identity is inconsistent with the appearance; and
providing a notification of the discrepancy, the notification being at least one of a visual notification or an audible notification.

3. The secure checkout method of claim 2, further comprising determining a true identity of the item if the identity is inconsistent with the appearance to determine whether the discrepancy is either error or fraud.

4. The secure checkout method of claim 1, the scan being received and the image being captured pursuant to a shopping event, and the secure checkout method further comprising storing the scan, the image, and the shopping event.

5. The secure checkout method of claim 1, the image capture device being selected from a group consisting of a still image camera or a video camera.

6. The secure checkout method of claim 1, further comprising:
segmenting the image from a background; and
extracting at least one visual feature of the item to determine the appearance.

7. A secure checkout system, comprising:
a module for receiving a scan of a barcode associated with an item via a handheld scanner;
a module for determining an identity of the item based on the barcode;
a module for receiving a capture of an image of the item via an image camera device collocated with the handheld scanner; and
a module for determining whether the identity is consistent with an appearance of the item as determined from the image.

8. The secure checkout system of claim 7, further comprising:
a module for registering a discrepancy if the identity is inconsistent with the appearance; and
a module for providing a notification of the discrepancy, the notification being at least one of a visual notification or an audible notification.

9. The secure checkout system of claim 8, further comprising a module for determining a true identity of the item if the identity is inconsistent with the appearance to determine whether the discrepancy is either error or fraud.

10. The secure checkout system of claim 7, the scan being received and the image being captured pursuant to a shopping event, and the secure checkout system further comprising a module for storing the scan, the image, and the shopping event.

11. The secure checkout system of claim 7, the image capture device being selected from a group consisting of a still image camera or a video camera.

12. The secure checkout system of claim 7, further comprising:
a module for segmenting the image from a background; and
a module for extracting at least one visual feature of the item to determine the appearance.

13. A program product stored on a computer readable medium for securely checking out, the computer readable medium comprising program code for causing a computer system to:
receive a scan of a barcode of an item via a handheld scanner;
determine an identity of the item based on the barcode;
receive a capture of an image of the item via an image camera device collocated with the handheld scanner; and
determine whether the identity is consistent with an appearance of the item as determined from the image.

14. The program product of claim 13, the computer readable medium further comprising program code for causing the computer system to:
register a discrepancy if the identity is inconsistent with the appearance; and
provide a notification of the discrepancy, the notification being at least one of a visual notification or an audible notification.

15. The program product of claim 14, the computer readable medium further comprising program code for causing the computer system to determine a true identity of the item if the identity is inconsistent with the appearance to determine whether the discrepancy is either error or fraud.

16. The program product of claim 13, the scan being received and the image being captured pursuant to a shopping event, and the computer readable medium further comprising program code for causing the computer system to store the scan, the image, and the shopping event.

17. The program product of claim 13, the image capture device being selected from a group consisting of a still image camera or a video camera.

18. The program product of claim 13, the computer readable medium further comprising program code for causing the computer system to:
segment the image from a background; and
extract at least one visual feature of the item to determine the appearance.

19. A method for deploying a system for securely checking out, comprising:
providing a computer infrastructure being operable to:
receive a scan of a barcode of an item via a handheld scanner;
determine an identity of the item based on the barcode;
receive a capture of an image of the item via an image camera device collocated with the handheld scanner; and
determine whether the identity is consistent with an appearance of the item as determined from the image.

20. The method of claim 19, the scan being received and the image being captured pursuant to a shopping event, and the computer infrastructure further being operable to store the scan, the image, and the shopping event.
